(19) United States
(12) Patent Application Publication
(10) Pub. No.: US 2005/0232227 A1
(43) Pub. Date: Oct. 20, 2005

(54) Method and apparatus for characterizing an end-to-end path of a packet-based network

(76) Inventors: Loki Jorgenson, Vancouver (CA); Robert Christopher Norris, Vancouver (CA)

Correspondence Address: FISH & RICHARDSON, PC, 12390 EL CAMINO REAL, SAN DIEGO, CA, 92130-2081, US

(21) Appl. No.: 11/051,353

(22) Filed: Feb. 4, 2005

Related U.S. Application Data
(60) Provisional application No. 60/541,928, filed on Feb. 6, 2004.

(51) Int. Cl. H04L 12/28

(52) U.S. Cl. 370/351

(57) ABSTRACT

The present invention provides a method and apparatus for characterising a path between a source host and a destination host, including characterisation of each segment of the network path between the source host and destination host. The present invention comprises a first stage of data collection, wherein sampling of a network path is enabled by means of sending and receiving specific predetermined ordered groups of packets that can vary in size, number and protocol, wherein all packets are sent from the source host and addressed to the destination host. These ordered groups of packets include strategically arranged marker packets and load packets, wherein the load packets are typically expired at a predetermined node between the source host and destination host, and the marker packets complete their journey to the destination. After expiry of the load packets of a particular ordered group of packets, the marker packets associated therewith provide a means for capturing information relating to network characteristics up to the expiry of these load packets. Subsequent analysis of the collected information enables the characterisation of each segment along a network path between the source host and destination host. The present invention can incorporate a further analysis of the collected information performing a correlation between the characteristics of the ordered groups of packets and the collected information, thereby enabling a means for the adjustment of the characteristics of the ordered groups of packets used during sampling that can result in an optimisation of the sampling and characterisation of the network path.

### CROSS-REFERENCE TO RELATED APPLICATIONS

This application claims the benefit of U.S. Provisional Application Ser. No. 60/541,928, filed Feb. 6, 2004.

### FIELD OF THE INVENTION

The present invention pertains to the field of networks and in particular to a method and apparatus for evaluating an end-to-end path of a packet-based network.

### BACKGROUND

In packet-based networks, it is often desired to test communications between two specific nodes on the network. This can generally be affected from a first one of the nodes by requesting the other node to “loop-back” a test packet sent from the first node. The first node, upon receiving back the test packet, can thereby ascertain not only that communication is possible with the other node, but also the round trip time for the packet. Inter-networking protocols such as the ARPA Internet Protocol (IP) may also provide a facility for determining reachability and round trip time by use of a looped-back test packet. Thus, in IP networks the Internet Control Message Protocol (ICMP) allows control and information messages, including echo request and echo reply messages, to be passed in the data portion of IP datagrams between IP software on different hosts and gateways. Other messages allowed by ICMP include timestamp request and timestamp reply messages which permit a transit time estimate to be made in both transit directions. Certain computer operating systems permit users to send ICMP echo requests using a command named “ping” with the users being able to specify the number and size of test packets for which round trip times are determined.

It may also be noted that in the ARPA Transmission Control Protocol (TCP), a similar measurement is continually made as part of the transmission control process. More particularly, the round-trip time is measured between the transmission of a packet and receipt back of an acknowledgement from the destination node; this round-trip time is averaged continually into a smoothed round-trip time estimate, which is then used to control the retransmissions time-out parameter (RTO).

U.S. Pat. No. 5,477,531 provides a method and apparatus for testing a packet-based network. The method of testing a packet-based network to ascertain characteristics of packet transmission between first and second nodes on the network comprises the steps of transmitting packets between these nodes, receiving the packets at one node, and correlating packet transmission and reception to derive correlation data indicative of a transmission characteristic, characterized in that the packets are transmitted as a sequence in which the packets are in a predetermined relationship to each other with one parameter varied over the sequence. The correlation data being derived is sensitive to this predetermined relationship thereby enabling a characteristic of transmission to be determined that is unobservable from the passage of a single packet.

U.S. patent application No. 2002/0080726 provides a system and method for determining network throughput rate and streaming utilization. A plurality of network evaluation signals, or probative test packets, are selectively sent and received through the network. Responsive to these evaluation signals, selective network evaluation parameters are determined and stored. Queuing theory analysis, responsive to these parameters, determines the response time and throughput characteristics, including streaming capacity, utilization and performance, of the network. In particular, this method uses uniform bursts of ICMP Echo packets of various sizes which are sent to each host in a network path to the desired destination. The subsequent analysis of the ICMP Echo Reply responses makes certain assumptions about how the packets are handled and experience the network path, and in particular, the packets are required to have no losses and arrive in the same order as transmitted.

The above identified United States patent and patent application both transmit ICMP packets to characterize the network path. These types of packets may be handled differently from other protocols, due to, for example, ICMP rate-limiting, protocol specific routing and blocking, and anti-DDOS (Distributed Denial Of Service) measures. Furthermore, the transmitted packets that are addressed to intermediate hosts between the source and destination can often take alternate routes compared to the path to the destination, thereby resulting in characterization errors of the source-to-destination path. In addition, these forms of evaluation techniques can be sensitive to asymmetries in the network path.

One algorithm used for the characterization of a network is the packet pair technique which intends to estimate the capacity of a network path from the dispersion of two equal-sized probing packets sent back-to-back. For example, this technique is intended to evaluate bandwidth and the presence of bottlenecks along the network path. This method evaluates the relative separation between the two packets and analyzes the statistics of the collection of such measures. This technique is well known having been originated by Robert Crovella and Mark Crovella as disclosed in “Measuring Bottleneck Link Speed in Packet-Switched Networks,” Performance Evaluation, Vol. 27-8, pp. 297-318, October 1996. Packet pair dispersion techniques however, have been criticized for their low accuracy, particularly in the presence of cross traffic.

A further algorithm that can be used for network analysis is one that is packet-train based. Specifically, packet-train based tools regard the dispersion of packets inside the packet-trains, with the benefit of having reduced statistical variance. Further they determine the amount of cross traffic by loading the network and analyzing the resistance to that loading. Algorithms that are based on packet-trains measure the arrival time of each car which is a subcomponent of the train comprising multiple packets, but does not measure the arrival time of each individual packet as is the case with packet pair dispersion. Packet-train based algorithms can adjust the car size to fit the system time resolution or timer resolution associated with high speed networks, while packet pair dispersion based algorithms typically rely on how accurately they can measure the timing of individual packets sent over the network. U.S. patent application No. 2002/0080726 describes a packet-train based method.

A third and distinct algorithm applies a method known as tailgating, wherein typically a small packet is sent immediately after a large packet, wherein the two packets are sent as a pair. It is known that the larger packet will typically limit the travel of the smaller following packet due to the greater serialization time the larger packet requires at each forwarding node. At some point along the network path to a destination, the larger packet will be removed, typically by means of the TLL (Time To Live) expiry mechanism, and the smaller packet will complete its journey alone. This method is applied in prior art such as developed and disclosed by Kevin Lai and Mary Baker in Measuring Link Bandwidths Using A Deterministic Model Of Packet Delay, SIGCOMM, 283-294, 2000, and represented by the prototype tool called nettimer. The benefits of this approach are that it usually consumes less network bandwidth, does not rely on consistent behaviour of routers handling ICMP packets, and does not rely on timely delivery of acknowledgments. This technique however, is known to have a very low level of accuracy.

A hybrid method that is a derivative of packet-trains and packet pair dispersion is disclosed by Attila Pasztor and Darryl Veitch in Active Probing using Packet Quartets, Proceeding of the Internet Measurement Workshop 2002, ACM SIGCOMM. This hybrid method also provides a means for the sampling of an IP network. In this method TTL Expiry is applied to expire packets in the “packet quartet” sequence thereby providing a means to derive statistics related to mid-path hops. This method uses two pairs of tailgating packets to benefit from the use of packet pair dispersion between the two packets that remain after the larger packets are expired. A focus of the analysis for this technique for deriving maximum bandwidth and a delay variation analysis is applied explicitly in preference to a delay minimization scheme in order to generate these bandwidth characteristics. Consequently this technique analyzes the delay distributions for specific behaviours in order to determine the applicable analysis, thereby potentially resulting in the requirement of multiple analysis methods. A disadvantage of this evaluation technique is that high-speed scalability is identified and stated as an issue.

Therefore there is a need for a new method and apparatus for characterizing an end-to-end path of an IP network that includes the ability to overcome the identified problems associated with the prior art.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for characterizing an end-to-end path of a packet-based network. In accordance with an aspect of the present invention, there is provided method for characterizing an end-to-end path of a packet-based network, said method comprising the steps of: generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path; transmitting said one or more ordered groups of packets from said source host along said common end-to-end path; collecting data relating to the transmission of said one or more ordered groups of packets; and analysing said data thereby developing characteristics of the end-to-end path.

In accordance with another aspect of the invention, there is provided an apparatus for characterizing an end-to-end path of a packet-based network, said apparatus comprising: means for generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path; means for transmitting said one or more ordered groups of packets from said source host along said common end-to-end path; means for collecting data relating to the transmission of said one or more ordered groups of packets; and means for analysing said data thereby developing characteristics of the end-to-end path.

In accordance with another aspect of the invention, there is provided a computer program product comprising a computer readable medium having a computer program product comprising a computer readable medium having a computer program recorded thereon for performing a method for characterizing an end-to-end path of a packet-based network comprising the steps of: generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path; transmitting said one or more ordered groups of packets from said source host along said common end-to-end path; collecting data relating to the transmission of said one or more ordered groups of packets; and analysing said data thereby developing characteristics of the end-to-end path.

### BRIEF DESCRIPTION OF THE FIGURES

FIG. 1 is a schematic representation of a network path between an origin and a destination including a number of layer 3 devices, for example routers or gateways, therebetween.

FIG. 2 is a schematic representation of a network path defining the components according to one embodiment of the present invention.

FIG. 3 is a schematic representation of an ordered group of packets thereof according to one embodiment of the present invention.

FIG. 4 is a schematic representation of an ordered group of packets according to another embodiment of the present invention.

FIG. 5 is a schematic representation of an ordered group of packets travelling along a network path from a source host to a destination host and the transmission of information to the sink host according to one embodiment of the present invention.

FIG. 6 is a Van Jacobson diagram illustrating how the distribution of packets in time is modified by variations in the capacities of a segment through which they pass.

FIG. 7 is a Van Jacobson diagram illustrating how the separation of the marker packets reflects the effect of bottlenecks or restrictions along the network path up to and including the node at which the load packets expired.

FIG. 8 illustrates an ordered group of marker and load packets indicating each packet identifier according to one embodiment of the present invention.

FIG. 9 is a schematic representation illustrating differences between round trip time (RTT) and total trip time (TTT) for the fourth packet in an ordered group of packets.

FIG. 10 is a schematic representation of the data required for the calculation of the one-way bitrate of an IP network to hop h, having regard to the relevant loads and markers and their transmission and reception timing.

FIG. 11 is an example histogram representing the round trip time (RTT) observed using the sampling stage according to the present invention, wherein the variation is dependent on the cross traffic experienced by the packets being monitored. This example histogram includes approximate identification of the minimum, mean and standard deviation of the RTT for this example.

FIG. 12a is a schematic representation of an example of the maximum bitrate available in a particular section of a network in the absence of cross traffic.

FIG. 12b is a schematic representation of an example of the bitate available for transmission in the same section of a network in the presence of cross traffic.

### DETAILED DESCRIPTION OF THE INVENTION

Definitions

The term “source host” is used to define the location or node of a network from which transmission of the packets for characterising the network path originate.

The term “destination host” is used to define the location or node of a network that defines an end-to-end path with regard to a specific source host.

The term “target host” is used to define the location or node of a network about which characteristics are to be collected. A target host can be intermediate between the source host and the destination host and may alternately be the destination host.

The term “sink host” is used to define the location or node of a network at which information regarding the status of the transmitted packets is collected. The sink host can be any node within the network, including the source host, destination host, target host or a node that is not along the path being characterised.

The term “packet” is used to define a piece of information that is being transmitted over an packet-based network. The size of a packet can vary greatly depending on a number of criteria including for example network capacity and size practicality. A packet is a unit of data that is routed between an origin and a destination on the Internet or any other packet-switched network. For example, when a file or other type of information is to be transmitted over a packet switched network, this file can be divided into “chunks” or packets that are of an efficient size for routing within the network.

The terms “load packet” and “load” are interchangeably used to define a packet transmitted on a network that provides a means for loading the network in order to generate a certain response. A load packet may be expired after a predetermined number of node traverses or “hops” along a path to a predetermined destination host.

The terms “marker packets” and “markers” are interchangeably used to define packets transmitted on a network that tag or mark the loads transmitted therewith. Marker packets are used to mark a response by a network to the transmission of the loads associated therewith. A marker packet is addressed to a predetermined destination host. A marker packet can reach the destination host or alternately a marker packet may be expired after a predetermined number of hops, provided the loads packets originally associated therewith have previously expired.

The term “layer 3” is used to define the network layer of a communication model which provides routing information, addressing and other related services enabling the transmission of information over an IP network. For example in a commonly referenced multilayered communication model termed Open Systems Interconnection (OSI), layer 3 is concerned with, for example, knowing the address of the neighbouring nodes in the network, selecting routes, quality of service, and recognizing and forwarding incoming messages from local host domains to the transport layer (layer 4), wherein the transport layer ensures the reliable arrival of messages and provides optional error checking mechanisms and data flow controls. While it may be noted that layer 3 may be specific to a particular protocol, it is assumed that the definition of layer 3 can additionally be used to define a comparable operational layer in any alternate packet-based communication model.

The term “layer 3 device” is used to define a device that operates on layer 3 of a packet-based communication model which may be termed the network layer. A layer 3 device can include for example a router, or other network layer suitable device as would be readily understood by a worker skilled in the art.

The term “segment” is used to define a portion of a network path between adjacent hosts that are responsive at layer 3, wherein a host can be a source host, target host, sink host or destination host. A segment further comprises one host that can be considered to be at the start or end of the segment.

The phrase “high speed network” is used to define a packet switching network that is capable of operating at rates in excess of 10/100 Mbps, or more generally, operating at rates in excess of typical Local Area Networks (LAN) of the day.

Unless defined otherwise, all technical and scientific terms used herein have the same meaning as commonly understood by one of ordinary skill in the art to which this invention belongs.

The present invention provides a means for real-time, non-intrusive characterisation of the end-to-end path of a packet switched network and all segments therebetween while operating independently of the end-hosts and does not require remotely deployed agents for operation. The present invention can be characterised effectively as a one-ended technique or effective one-way measure that does not load the network to its capacity or measure the return path. It can flexibly operate under a range of conditions and can operate in the presence of rate-limiting and anti-DDOS (Distributed Denial Of Service) mechanisms. The present invention can additionally characterise the effect of the network path in terms of non-ICMP (Internet Message Control Protocol) protocols such as UDP (User Datagram Protocol) and TCP (Transmission Control Protocol) in addition to the identification of protocol/application-specific behaviours, for example traffic shaping and rate-limiting. The present invention is additionally scalable such that it is capable of characterising transmission paths of high-speed networks.

The present invention provides a method and apparatus for characterising a path between a source host and a destination host, including characterisation of each responsive segment of the network path between the source host and destination host. The present invention comprises a first stage of data collection, wherein sampling of a network path is enabled by means of sending and receiving specific ordered groups of packets that can vary in size, number and protocol, wherein all packets are sent from the source host and addressed to the destination host. These ordered groups of packets include strategically arranged marker packets and load packets, wherein the load packets are typically expired at a predetermined node between the source host and destination host. After expiry of the load packets of a particular ordered group of packets, the marker packets associated therewith provide a means for capturing information relating to network characteristics up to the expiry of these load packets. This information relating to the interaction of these ordered groups of packets with the network is collected at the sink host, which may or may not be a node along the network path between the source and destination hosts. Subsequent analysis of the collected information enables the characterisation of each segment along a network path between the source host and destination host. The present invention can incorporate a further analysis of the collected information by performing a correlation between the characteristics of the ordered groups of packets and the collected information, thereby enabling a means for the adjustment of the characteristics of the ordered groups of packets used during sampling that may result in an optimisation of the sampling and characterisation of the network path. The present invention provides a means for the use of a variety of protocols thereby providing a means for selecting for a network's response to a particular protocol while providing a means for following the ordered group of packets and evaluating the response of the network thereto.

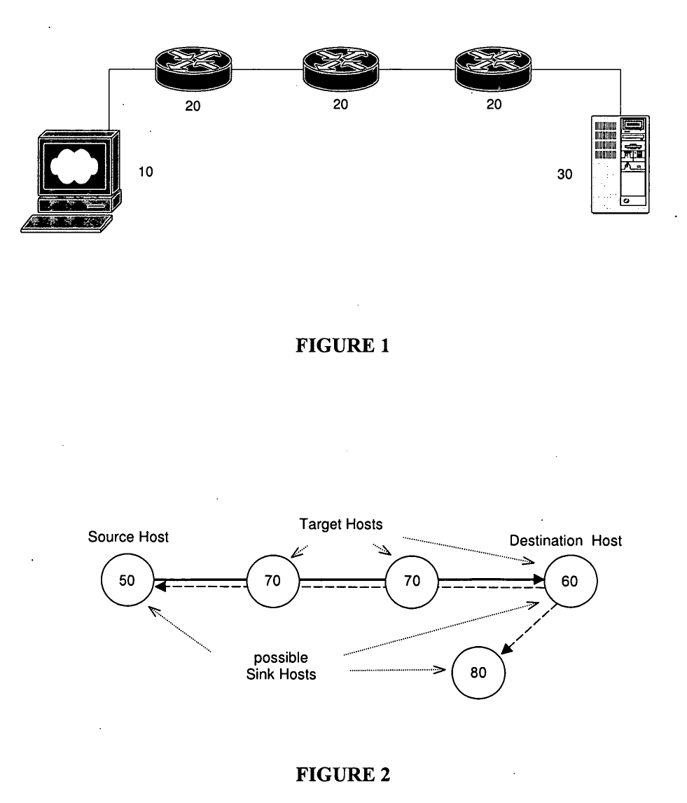

With reference to FIG. 1, a potential network path between an origin 10 and a destination 30 is illustrated, wherein this path can be separated into a number of segments by a number of layer 3 devices, for example a router 20. Having regard to the present invention, a path between a source host 50 and a destination host 60 is illustrated in FIG. 2, wherein between the source and the destination hosts are a number of layer 3 devices or target hosts 70. A sink host 80 is also integrated into the present invention, wherein the sink host can be any one of the hosts along the network path or may be a node outside the path being evaluated. According to the present invention, ordered groups of packets originate at the source host 50 and are addressed to the destination host 60. The configuration of these ordered groups of packets and their interaction with the network enable the determination of characteristics regarding each target host 70, along the network path from the source host to the destination host. Information relating to the transmission of the ordered groups of packets during the sampling session is received at the sink host 80, for analysis.

Connected to the network are one or more mechanisms for sending the ordered groups of packets along a path and receiving the ordered groups of packets or responses thereto, after they have traversed the path. In one embodiment, ordered groups of packets originate at a packet sequencer travel along a path to a reflection point and then propagate back to the packet sequencer and in this embodiment the packet sequencer can be positioned at the source host. In an alternate embodiment a packet sequencer is positioned at the source host for collecting transmission test data, and another packet sequencer can be positioned at the sink host for collecting information relating to the reception the ordered groups of packets or responses thereto. A packet sequencer can record information about the times at which packets are dispatched and the times at which returning packets are received. A packet sequencer can additionally collect information relating to the type of packets transmitted and the types of packets received, for example. All information collected during the sampling stage is considered to be test data.

In addition coupled to the network is an analysis system for receiving the test data and performing a desired analysis thereof, in addition to adaptation or modification of the sampling analysis if required. The analysis system may comprise a programmed computer or may be configured in hardware, or other form of computational system as would be readily understood by a worker skilled in the art. The analysis system may be hosted in a common device or located in a common location with a packet sequencer or alternately may be physically separated therefrom. For example, the analysis system and a packet sequencer can both be located at the source host, wherein the source host is also functioning as the sink host. The position of a packet sequencer and the analysis system can be dependent on the selection of the source host and the sink host.

Sampling Stage

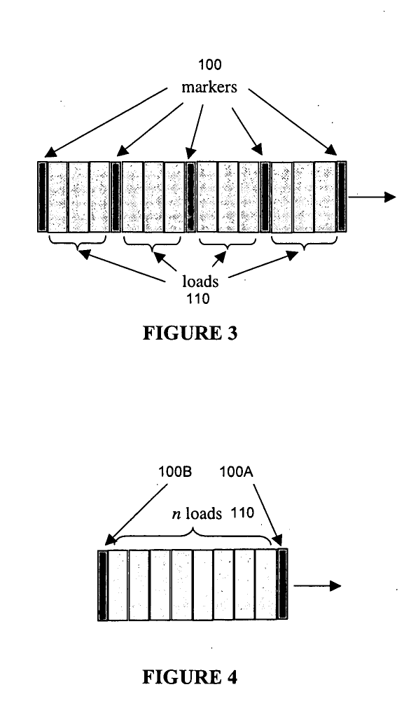

The sampling technique integrates the use of “loads and markers” wherein certain packets play the role of “loading” the network to generate a certain response, and other packets play the role of “marking” the response and returning to the sink host for analysis. A variety of configurations of patterns of loads and markers are possible, wherein varying configurations can be used to sample a network path for a particular characteristic or characteristics. The most general configuration includes an ordered group of load packets 100 interspersed with marker packets 110 as illustrated in FIG. 3. While FIG. 3 illustrates an equal number of loads between adjacent markers, this is not to be considered a limitation, but merely one embodiment of a more general configuration of an ordered group of packets. Certain characteristics can distinguish loads from markers such as header values, protocol and size, wherein the number and position of the markers depends on the implementation. The markers make it possible to track the position and behaviour of the entire ordered group of packets without the resulting required system overhead and the disadvantage of tracking each individual packet transmitted. In addition, it can be observed that in many instances it is infeasible to both provoke a response from a network path and observe that response. For example, if all of the packets being sent along the network path are of the configuration ICMP Echo, rate-limiting mechanisms along the network path may alter the response of the path relative to other protocols. By sending other protocols, however, it may be difficult to observe a desired response. Therefore, by imbedding packets that generate easily observable responses within ordered groups of packets of the desired protocol for generating a desired response, one can observe the function of a network path under the desired conditions and subsequently characterise that functionality.

In one embodiment of the present invention and with reference to FIG. 4, a first configuration of an ordered group of packets includes a first marker packet 100A followed by a series of load packets 110 and finally a second marker packet 100B. In this configuration, the preceding and following marker packets provide a means for marking the response of a network path to the load packets therebetween.

In one embodiment of the present invention, the marker packets are the same size as the load packets, however this configuration can be manipulated in order to determine an optimal choice for the size of a marker for use during a desired sampling session, for example. The markers are typically ICMP Echo packets, however, they may equally be defined using other protocols such as UDP or TCP, wherein the selection of protocol can be determined based on the implementation and desired characterisation of a network path. The markers are typically addressed to the destination host, however other nodes along the network path can be selected as the desired destination of the markers. Further, the markers may also be expired at some node prior to the destination, however in this case the loads have expired at a previous node. This action may evoke some response from the node at which the markers expire, for example. In addition, the markers are also configured in order to identify the desired location for the receipt of information relating to the transmission of the ordered groups of packets, for example the ICMP Echo reply packets. In the present invention this desired location is the sink host, wherein the sink host can be a node along the network path being characterised or can be external thereto.

In one embodiment of the present invention, the load packets are identical in size and are typically created as the largest size permitted by the partial path or segment MTU (Maximum Transfer Unit) from the source host to the adjacent target host. The loads may be configured using any protocol, for example ICMP, UDP or TCP, however in one embodiment of the present invention the loads are configured using UDP. During the configuration of the loads, they are addressed to the destination host, however under certain conditions other nodes along the path may be selected for this parameter. In addition, the loads are configured with a TTL (Time To Live) value in their IP headers that is set to specific values in order that they will expire at specific layer-3 nodes or target hosts along the network path being characterised. For example, a load configured with a TTL=1 will expire at the first hop or layer 3 device traverse and a load configured with a TTL=2 will expire at the second hop. Upon the expiry of a load at a predetermined hop, information relating to the loads interaction with the network path up to that hop will be subsequently transmitted to the sink host. It is important to note that the one or more load packets between two specific marker packets have been configured with the same TTL.

In one embodiment of the present invention, the sampling stage commences with each of the layer 3 nodes along the network path to a selected destination host being identified. This identification process can use, for example a layer 3 traceroute mechanism to determine the reachability of the identified destination and the number of nodes therebetween. Subsequently a series of packets comprising loads and markers are sent to the destination host with the TTL Expiry on the loads set to cause them to expire at different target hosts. In one embodiment, the loads may be composed of packets of any preferred protocol, for example UDP, and the markers may be composed of ICMP Echo packets. The expiring loads can result in ICMP TTL Expiry messages being generated by the target host where expiry occurs and these messages are forwarded to the pre-assigned sink host. The markers would continue on to the destination host and can result in ICMP Echo Reply packets being sent back the sink host, for example if the markers are generated using ICMP. Alternately the markers might be expired at a node subsequent to the load expiry and TTL Expiry messages relating to the markers are sent back to the sink host. Through the collection and analysis of information relating to the time of commencement of the transmission of the ordered group of packets and the receipt time of the resulting messages and replies by the sink host, the characterisation of each segment of the network path between the source host and the destination host can be evaluated. In one embodiment, the source host would also be the sink host and in an alternate embodiment the destination host is the sink host. If this is not the case, the markers and the loads can be configured to specify a distinct sink host for the transmission of the messages and reply packets. In this case additional synchronization of the transmit and receive timings is required, for example using a Global Positioning System (GPS), in order to achieve comparable accuracy by taking into account the addition or reduction of time for message and reply packet travel time based the location of this distinct sink host.

In another embodiment, a comparable mechanism for deriving a response to the marker packets can be achieved by composing the markers in other protocols in order to generate an error response from the destination host. For example, markers may be composed using UDP protocol and configured to use an inactive port at the destination host. The UDP marker packets can generate an ICMP Port Unreachable response. In any embodiment, however, it should be noted that, the choice of protocol for the load packets is independent of the choice of protocol for the marker packets.

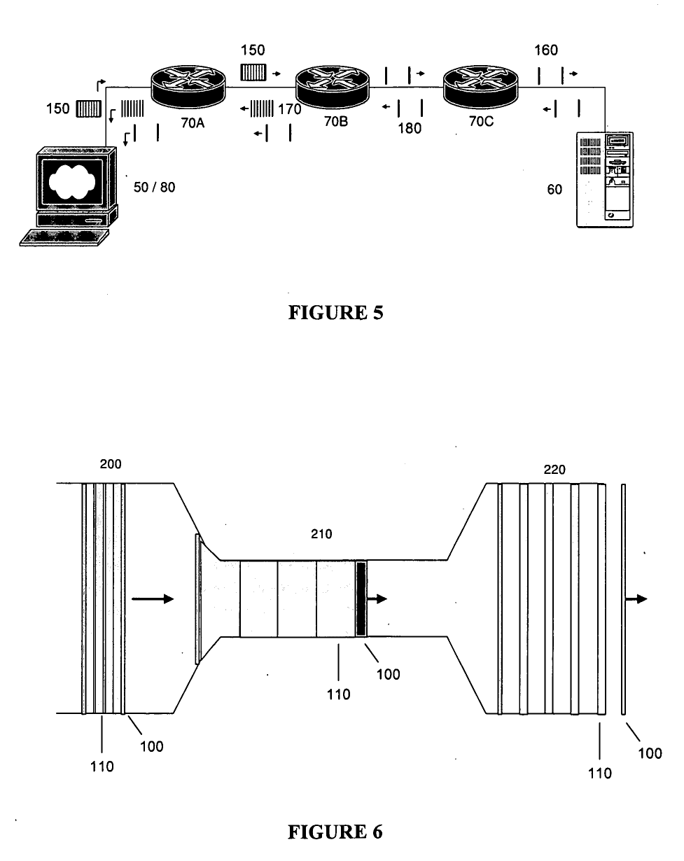

An example of the movement of an ordered group of packets generated according to the present invention is illustrated in FIG. 5. At the source host 50 the ordered group of packets 150 is created and addressed to the destination host 60, wherein the load packets are configured with a TTL equal to 2 and marker packets precede and follow the load packets. The ordered group of packets traverses the first target host 70A, where the TTL of the packet is decremented, and proceeds along the second segment to the second target host wherein the load packets are expired and information 170 relating to their movement along the network path is transmitted to the predetermined sink host 80 for collection and subsequent analysis. As an example this information can be in the form of ICMP TTL Expiry messages from the second target host 70B. The marker packets associated with the ordered group of packets initially transmitted, continue along the network path to the destination host 60, where they are reflected to the predetermined sink host 80 for collection and subsequent analysis. As an example this information can be in the form of ICMP Echo Reply packets that are returned to the host of origin. In this example, the third target host, 70C, may not influence the timing and spacing measurements of the returned information, as this target host may not result in a modification of the spacing between the two marker packets, while these marker packets provide information relating to the interaction of the ordered group of packets with the network up to and including the second target host 70B. After expiry of the load packets, the spacing between the marker packets may be changed if one of these marker packets experiences cross-traffic within the network while the other marker packet remains unaffected.

As the load packets pass along the network path they are affected by the network devices through which they pass or traverse and interaction with other aspects associated with the network. Bandwidth constrictions, opposing traffic and variations in the network path, for example, can perturb the loads and consequently the associated markers. For example, the distribution of the timing of the TTL Expiry and Echo Reply packets returning to the sink host, relative to the originating packets from the source host, are measured in terms of load count, packet size, round trip times, total trip times, packet loss, spacing and ordering. This data can provide a means for evaluating the effect of these and other network characteristics.

FIG. 6 illustrates the effect of a low capacity segment on the spacing of the marker and load packets, previously travelling along a higher capacity segment. This effect is represented in the form of a Van Jacobson diagram. The spacing between packets can be introduced at the bandwidth constrictions that appear in the path. As illustrated in FIG. 6, the ordered group of packets is tightly spaced within the high capacity segment 200 prior to reaching the low capacity segment 210. Upon reaching the low capacity region the transmission rate of the packets is reduced thereby resulting in an increase in the spacing between adjacent packets. Upon reaching the subsequent high capacity segment 220, the packets are typically unable to reduce this space created during the traverse of the low capacity segment and as such the spacing between the packets is indicative of the correlation between the transmission speeds of the two different segments of the network path. The spacing between the packets, however, may be altered in the presence of cross traffic experienced along the network, wherein this factor may decrease the spacing between these packets if it affects only some of the packets and not all of the packets in the ordered group of packets, wherein the cross traffic can result in the increased delay of the affected packets. The presence of cross traffic and its influence on the packets can be detected permitting packets affected by cross traffic to be distinguished from packets that have not encountered cross traffic.

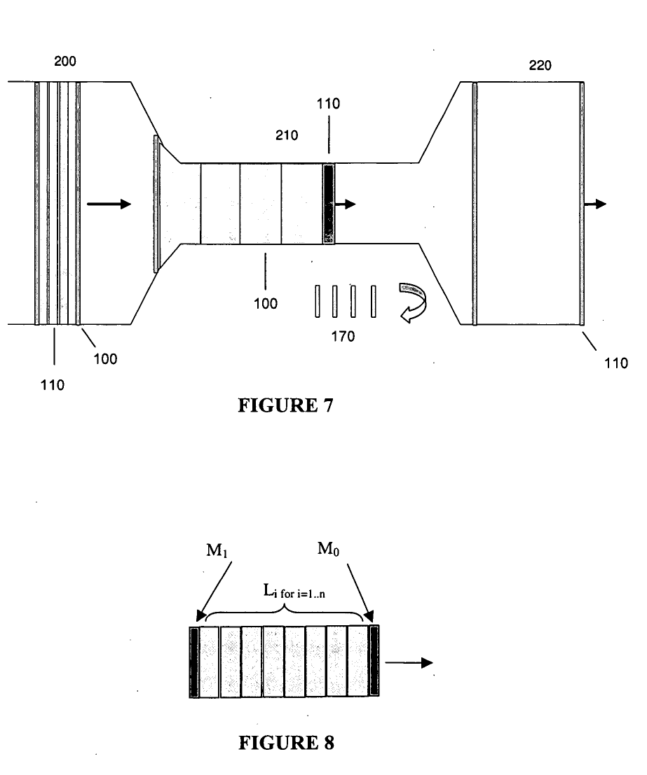

FIG. 7 illustrates the perceived spacing of the markers 110 subsequent to the expiry of the load packets after traversing the low capacity segment 210 and the generation of the messages 170 relating to the expiry thereof. In this manner, the spacing between the markers 110 can be representative of the effect of bottlenecks for example, along the network path to the destination host up to and including the node at which the load packets associated with this ordered group of packets, expired.

If the target host at which the load packets are expired, is a bottleneck or subsequent thereto, the marker packets may continue to the destination host while maintaining the separation therebetween from the point that the loads were expired. Under certain circumstances, the marker packets can make the balance of the trip to the destination host without being affected by any other phenomenon, for example subsequent bottlenecks and cross traffic. The marker packets that are reflected back from the destination host may also make the trip to the sink host without being influenced by other phenomenon. In the case where the markers encounter no other perceived effects, marker replies can arrive at the sink host with an inter-packet separation representative of the node at which the loads were expired, thereby providing a means for characterising that segment of the network path. In the case where the separation of the marker packets is sufficiently large, a low capacity segment traversed subsequent to the load packet expiry, may not affect the spacing of the marker packets. In this case the reduction in the transmission speed of the first marker packet at the low capacity segment may not result in any further delay of the second marker packet and thus the spacing between the marker packets can remain constant subsequent to the expiry of the load packets. This spacing between the marker packets will typically not decrease, however if cross traffic interacts with one of the marker packets and not the other, for example, a reduction in the spacing between the marker packets may occur.

As an example, marker and marker replies that have been delayed by competing traffic have encountered each other in queues, or have been lost, can be isolated in the distribution of replies from those marker replies that have returned without further influences by the network path. In one embodiment, responses from the network that are selected for analysis of maximum bitrate will be based on the markers with the smallest Total Trip Time (TTT), when all replies related to the expired loads are received, and the markers in their original order of transmission. Other analyses may have other requirements for data selection. The distribution of reply packets, both for loads and for markers, are maintained and analyzed in order to reveal a broad range of characteristics about the network path. These characteristics can be based on parameters such as packet size, packet count, protocol, and TTL, which had been set upon the initial transmission of the ordered group of packets. Through the analysis of the distributions of the marker replies in relation to their initial transmission, together with information relating to the transmission, expiry and receipt of expiry messages relating to the loads, the end-to-end network path can be characterized on a “hop” by “hop” or segment by segment basis, from the source host to the predetermined destination host. This characterization of the network path includes measurements comprising one-way maximum bitrate, one-way propagation delay, one-way delay variation and one-way available bitrate.

Based on the above it is clear that the rate capacity of a packet-based network may not affect the ability of the sampling stage of the present invention to collect relevant information for subsequent analysis, thereby enabling the characterisation of the complete network path even for high speed networks. A typical limiting factor is the precision with which the ordered group of packets can be reliably placed on the network path, wherein this factor is dependent on the source host's Network Interface Card (NIC). In order to provide the desired level of characterisation, sufficient control of the NIC must be enabled such that the data collected relating to the time of transmission and reception of responses is of sufficient precision.

Analysis Stage Enabling Characterisation

The analysis stage enabling characterisation can be defined based on a predetermined series of assumptions relating to the network path capabilities and the ability to place the desired packets onto the network in a required fashion. As such for this analysis, it can be assumed that there exists a mechanism for the preparation and transmission of packets capable of reducing the effects of the operating system and other limiting processes on the rate of transmission such that packets being sent as part of a contiguous series are minimally separated in time. As such, the rate of transmission of the ordered group of packets from the source host can be limited primarily by the maximum transmission capacity of the source host's NIC. This parameter can be defined by its layer 2 specification, for example 100 Mbps for Fast Ethernet together with any layer 3 effects that may be present in the IP network, for example.

While the following procedure for performing the analysis assumes a specific ordered group of packets being transmitted, it would be readily understood by a worker skilled in the art, how one would expand the provided sequence of steps to ascertain desired measurements using alternately configured ordered groups of packets and as such is considered to be within the scope of the present invention.

In one embodiment of the present invention, FIG. 8 illustrates an ordered group of packets that will be used to sample the network and provide the required raw data necessary for the desired analysis of the network path, wherein the identity of each of the packets in the ordered group of packets is identified. A series of contiguously transmitted packets, referred to as Loads Lᵢ where i is the index in the series and is equal to an integer between 1 and n, are configured such that when transmitted at the maximum transmission capacity of the source host's NIC, the separation between these packets can be minimized. This ordered group of packets further comprises an additional two packets, wherein one precedes and the other follows the load packets and these additional packets are referred to as Markers M₀ and M₁ respectively. These markers are also contiguously transmitted with respect to the loads, wherein the separation between a marker and the adjacent load packet is minimized.

Each packet can be transmitted with a destination host specified as a particular IP address that is accessible from the source host, via the network under evaluation, with the source host specified as the sink host. The TTL parameter associated with both marker packets can be set to the maximum allowable value, for example TTL=255 and the TTL parameter associated with each load packet is set to an integer value h, ranging between 0<h<256 for example. This type of configuration typically allows the marker packets to reach the destination host, while the loads packets typically expire at a target host between the source host and the destination host. Within a particular ordered group of packets, the TTL value for each of the load packets is assigned the same value, however the TTL associated with the load packets of other ordered groups of packets is changed thereby treating this as a variable that corresponds to different target hosts. When the value of h is less than the number of layer 3 hops in the path between the source host and the destination host, the load packets Lᵢ will be expired and “TTL Expiry” messages will be sent by the target host to the sink host, such that one message is sent for each expired load packet. In the present example, the source host and sink host are identical, however, this may not be the case and as such corrections to the collected information are required to account for alternate configurations. The marker packets associated with a particular ordered group of packets will travel to the destination host regardless of the expiry of the associated load packets. Upon reaching the destination host, the destination host will transmit response packets, for example in the form of Echo Reply packets, to the sink host, wherein one Echo Reply is sent for each marker packet. In alternate embodiments, the marker packets may solicit ICMP Port Unreachable packets from the destination hosts, or the marker packets may solicit TTL Expiry packets from some node prior to the destination host.

In one embodiment, the load packets are defined using a protocol being characterised for UDP protocol and are of uniform size, S_{L}. The marker packets are ICMP Echo packets and are both of the same size S_{M}, which may be different from the size of the load packets, S_{L}. The ICMP TTL Expiry packets transmitted to the sink host from the target host at which the load packets expire, can be of another size, S_{E}, that can be relatively small, for example 64 bytes. The ICMP Echo Reply packets transmitted from the destination host to the sink host will be the same size as the original ICMN Echo marker packets, S_{M}.

In an alternate embodiment, each marker packet may be of a different size, resulting in ICMP Echo Reply marker packets being transmitted from the destination host to the sink host that are the same size as their respective original ICMP Echo marker packet. In a further embodiment, the marker packets may be of some other protocol such as UDP and, regardless of their original size, can generate ICMP Port Unreachable packets from the destination host to the sink host that can be relatively small, for example 64 bytes.

In one embodiment, the following provides the sequence of steps followed in order to enable the end-to-end sampling and analysis of a network path and to enable the characterisation of a selected packet-based network path segment by segment. A destination host is selected and optionally the number of layer 3 hops, H, and corresponding IP addresses of all of the visible layer 3 hops between the source host and destination hosts can be determined, thereby identifying all target hosts therebetween. Subsequently, multiple series of contiguous ordered groups of load and marker packets are transmitted to the destination host IP address. The expiry variable TTL associated with the load packets of different ordered groups of packets can be set to some value in the range 1 to H, thereby enabling the gathering of data from all of the target hosts between the source host and destination host up to and including the destination host. The transmit times for all of the packets are recorded at the source host for each probe packet and the returning packet times are recorded for each received expiry or reply packet at the sink host, wherein the respective timing relating to the transmitted packet and the resulting returned information therefrom are correlated for analysis. Statistics are generated for the timing of each packet within a packet series for a specific TTL value and once sufficient statistics have been recorded for each value of TTL, the statistics are used to derive a range of measurements associated with the target host identified by a particular TTL. This procedure can result in measurements being determined for each individual hop.

The results of the sampling stage of the network path according to the present invention, includes collections of statistical values that are attributed to each selected target host within the sampled end-to-end network path. The TTL value associated with the load packets transmitted during the sampling stage provides a means for correlation of the collected information with a particular target host. Therefore, each target host can have associated with it statistical values of the TTT which can be defined as the time from the beginning of transmission of the first packet in the series at the source host until the completed reception of the acknowledgement for the specific packet of the series at the sink host. In addition, each target host can have associated with it inferences from the TTT distribution such as loss and reordering, for example.

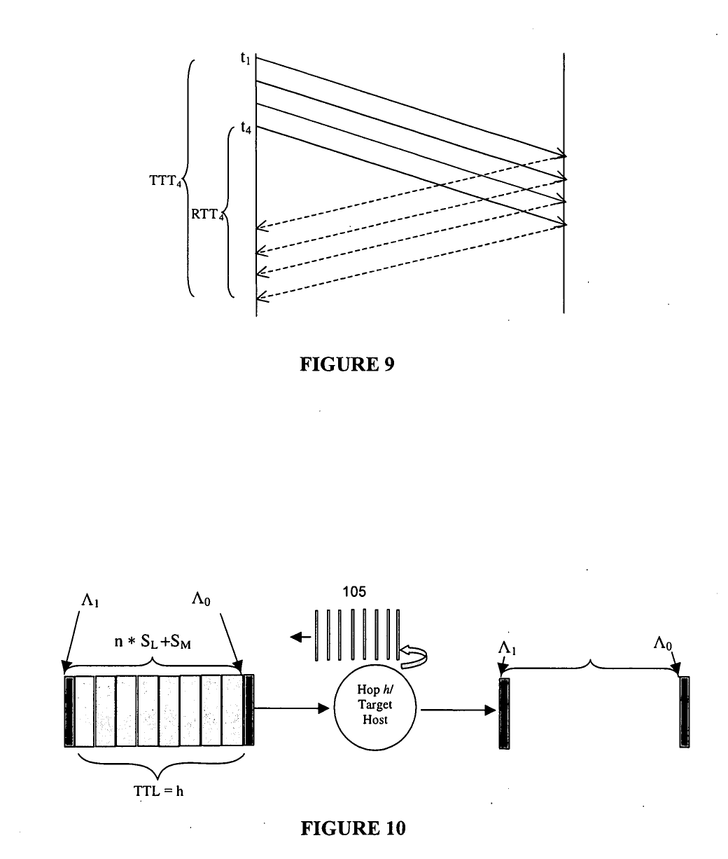

Individual packet timings can be based on the difference between the local time at the transmitting source host when a packet has completely left the network interface and when an acknowledgement packet has been completely received at the sink host. In one embodiment the timings are relative to the “trailing edge” of the packets sent and received. This measure can be referred to as the Round Trip Time (RTT) and is related to the TTT, wherein RTT is equal to the TTT less the time required for the transmission of the first packet through to the packet of interest. FIG. 9 illustrates in a standard time diagram, the relationship between TTT and RTT for the fourth packet in an ordered group, wherein time increases along the vertical axis of this plot.

During the sampling stage the values representing each of the identified symbols in Table 1 are determined based on the collected information. Table 1 introduces the nomenclature required to describe the analysis applied to the sampled packet statistics. Each measure assumes an appropriate filtering has been applied to the distribution of packet timings to select out only the eligible sample. For example, minimum TTT for the preceding and following markers may require that both values were derived from the same ordered group of packets. The values defined in Table 1 enable the evaluation of characteristics relating to segments of a packet-based network including one-way maximum bitrate, one-way propagation delay, one-way delay variation and one-way available bitrate.

The process for the derivation of these characteristics, according to one embodiment, is provided below considering the following assumptions. The sink host and the source host are the same. The destination host will generate ICMP Port Unreachable acknowledgement packets when the load packets are UDP and their TTL is set such that the defined target host is beyond the destination host, for example the TTL value associated with the load packets is greater that the number of hops between the source host and the destination host. The return path latency is symmetric with the outbound portion of the network path and sufficient sampling of the network has been performed for statistical significance of the information gathered for each target host to enable the desired analysis. Marker packets are assumed independent of one another once the load packets have expired such that they do not encounter each other in the queues of the layer 3 devices on the network path, or if they do encounter each other, that this fact can be detected and the affected packets can be analyzed appropriately.

TABLE 1

| Symbol | Meaning |
|---|---|
| Λ₀ | minimum TTT for preceding marker, M₀ |
| Λ₁ | minimum TTT for following marker, M₁ |
| αᵢ | minimum TTT for load, Lᵢ, where i = 1 . . . n |
| T₀ | mean TTT for preceding marker, M₀ |
| T₁ | mean TTT for following marker, M₁ |
| τᵢ | mean TTT for load, Lᵢ, where i = 1 . . . n |
| Ω₀ | maximum TTT for preceding marker, M₀ |
| Ω₁ | maximum TTT for following marker, M₁ |
| θᵢ | maximum TTT for load, Lᵢ, where i = 1 . . . n |
| Σ₀ | standard deviation of TTT for preceding marker, M₀ |
| Σ₁ | standard deviation of TTT for following marker, M₁ |
| σᵢ | standard deviation of TTT for load, Lᵢ, where i = 1 . . . n |
| Δ₀ | loss rate for preceding marker, M₀ |
| Δ₁ | loss rate for following marker, M₁ |
| δᵢ | loss rate for load, Lᵢ, where i = 1 . . . n |

One-Way Bitrate

As would be readily understood by a worker skilled in the art, the one-way bitrate can be considered the maximum rate at which bits are transferred in one direction between an origin and a destination. As illustrated in FIG. 6, when all packets in an ordered group of packets arrive at a bitrate bottleneck, for example a low capacity segment, the separation in time between the trailing edges of adjacent packets increases. In the absence of any other influence, for example a subsequent decrease in network capacity or cross traffic, this characteristic separation persists. Subsequent constrictions, for example further decreases in network capacity, may introduce further separations between the packets. Once the loads associated in a particular ordered group of packets are expired, the relative separation between the trailing edges of the two marker packets associated therewith remains fixed and representative of the presence of the loads at the time of their expiry. The marker separation can therefore act as a residual indication of the nature of the network path up to, but not beyond, the expiry point of the associated loads, assuming for example sufficient separation between the marker packets after expiry of the loads and no influence of cross traffic on one of the marker packets.

Circumstances that can increase or decrease the separation between the markers would also increase the overall time between transmission and reception of responses relating to the marker packets. By selecting the minimum time A₀ and A₁, the packets which traveled end-to-end without encountering any other traffic are most likely to be used for the evaluation of the one-way bitrate. The collection of sufficient statistical sampling can ensure that the minimum time for at least one pair of packets is representative of this characteristic as a first order estimate. Sensitivity of the network to other parameters, for example packet size, load count and protocol can further refine the characterisation of the network path. For example, with reference to FIG. 10, a schematic representation of the data required for the calculation of the one-way bitrate is illustrated. The TTL associated with the load packets for this ordered group of packets has been set at h and as such they expire after traversing target host h and the TTL Expiry packets 105 are sent to the predetermined sink host. The rate at which data can be transmitted, the one-way bitrate Bₘₐₓ up to the point of expiry of the loads, can be calculated as the total number of bits between two markers including any portion of the markers that lie between their trailing edges and is defined as follows:

$$\begin{matrix}{B}_{max} = \frac{\begin{matrix}total number of bytes between \\ trailing edges of markers\end{matrix}}{Difference of minimum total trip time of markers} \\ = \frac{( n * {S}_{L} + {S}_{M} )}{( {Λ}_{1} - {Λ}_{0} )}\end{matrix} \qquad ( 1 )$$

One-Way Propagation Delay

As would be readily understood by a worker skilled in the art, the one-way propagation delay can be defined as the time for an imaginary zero-byte packet to travel from an origin to a destination within an IP network. With regard to the present invention, the minimum RTT for the TTL Expiry acknowledgements to return from a target host represent the travel time for packets to make the round trip from the source host to this target host and back. Serialization time for the packets at each intermediate node is included in these RTT times, wherein serialization time is a function of packet size. In some cases the size of the transmitted packet may differ from that of the received packet. The propagation time from the source host to the target host for a zero byte packet, can be half the RTT for this zero-byte packet, since there is no consideration relating to serialization time due to the packet having a zero byte size and an assumption of symmetry of the return path.

In one embodiment, assuming that the load packets arrive at the target host in order, the first minimum time a, of the first load packet L₁ should be the smallest. This value comprises the time for the first marker packet M₀ and L₁ to travel to the target host plus the time for the TTL Expiry packet associated with the expiry of L₁ to return to the sink host, wherein α₁ can be determined as follows:

$$\begin{matrix}\begin{matrix}{α}_{1} = {t}_{1 \text{-} way prop} + {t}_{ser ( S ( {M}_{0} ) )} + {t}_{ser ( S ( {L}_{1} ) )} + \\ {t}_{1 \text{-} way prop} + {t}_{ser ( S ( {L}_{1} - expiry ) )}\end{matrix} & ( 2 ) \\ = 2 * {t}_{prop} + {t}_{ser ( {S}_{L} + {S}_{M} + {S}_{E} )} & ( 3 )\end{matrix}$$

where tₚᵣₒₚ is the 1-way propagation time and t_{ser(Sx)} is the 1-way serialization time for a packet of size Sₓ

Therefore, by varying the size of the load packets, S_{L} or the marker packets S_{M}, a range of values for the minimum RTT α₁ can be generated during the sampling stage. Assuming a linear dependence of α₁ on the size of the packet, Sₓ, the projected value of α₁ for a zero byte sized packet, Sₓ=0, can be estimated by the following and subsequently the one-way propagation can be estimated as α₁(0)/2.
α₁(0)=α₁(S_{large})−S_{large}*[(α₁(S_{large})−α₁(Sₛₘₐₗₗ))/(S_{large}−Sₛₘₐₗₗ)] (4)
where α₁(Sₓ) is the minimum TTT for a value of Sₓ=S_{L}+S_{M}+S_{E} and either or both S_{L} and S_{M} are varied in size so that S_{large>>}Sₛₘₐₗₗ
One-way Delay Variation

As would be readily understood by a worker skilled in the art, the one-way delay variation can be defined as the range of travel times for a packet along a specific path and may have a relationship with “jitter” present in the system. This measure represents the distribution of packet delay. For example in a busy network each packet may show a unique delay as cross-traffic levels vary dynamically within a network. In the context of the present invention, one-way delay variation is defined as the variability of the time for a packet to travel from the source host to the target host as it can be inferred from a distribution of the TTT of particular packets within a series of ordered group of packets over time.

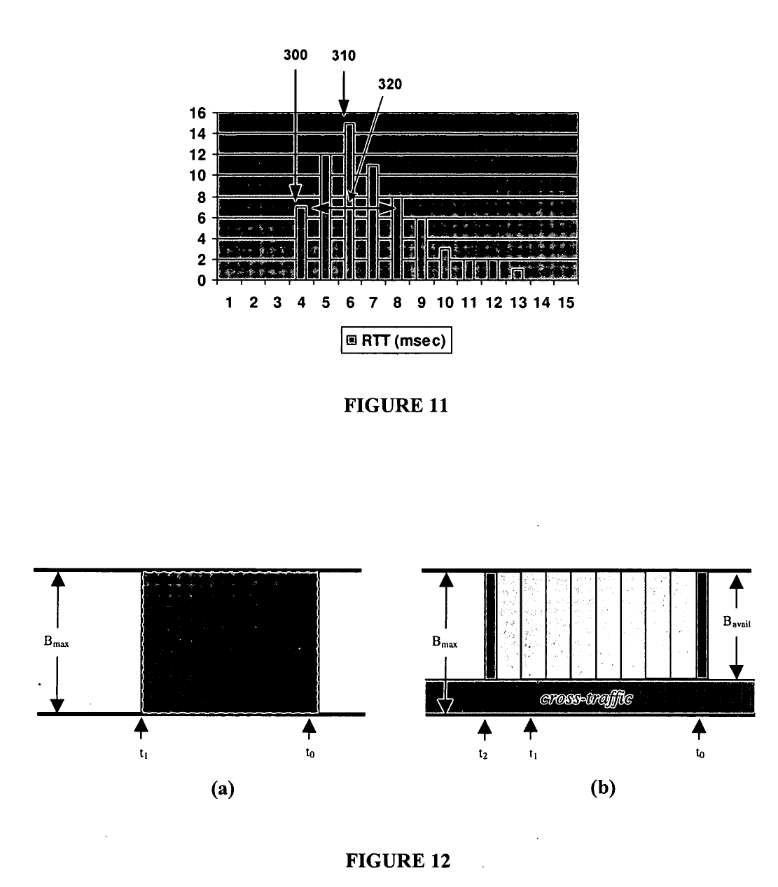

The TTT values for the loads, τᵢ, extracted during the sampling stage according present invention can represent key measures of this distribution. FIG. 11 illustrates a typical distribution of the RTT for the simplified case of a single packet—in this case RTT is identical to τ₀, TTT for an ordered group of packets containing only one packet—wherein RTT is represented on the x-axis in milliseconds and the frequency of occurrence of a particular RTT is represented on the y-axis. Additionally, the minimum time 300, mean time 310 and standard deviation 320 for this typical distribution is schematically represented. The RTT distribution may be a function of the packet size or packet type, for example. The distributions of TTT τᵢ for an ordered group of packets are similar in nature and can be derived from the individual RTT distributions.

An approximate single value representation of the entire distribution of the one-way delay variation can be equated to the coefficient of variation, CoV, defined as follows:

$$CoV = \frac{standard deviation}{mean} = \frac{σ}{τ} \qquad ( 5 )$$

wherein the selected standard deviation and mean are typically for the first or last load packet TTTs.

The one-way delay variation may be represented relative to the size or number of the load packets sent. Use of the mean TTT, however, includes assumptions about the nature of the return path such that it is symmetric in latency with the outbound path and limiting effects such as opposing traffic or protocol-specific rate limiting are negligible on the return path.

One-Way Available Bitrate

The one-way available bitrate can be used to describe the percentage of the maximum bitrate, Bₘₐₓ, that may be used by an application. In the presence of cross-traffic and other limiting effects that can vary with time, the available bitrate will typically vary with time. Any measure of the available bitrate infers some coarse-graining or averaging over time. The value of the available bitrate as considered by the present invention, represents the average value of the available bitrate over the period during which statistical sampling has been performed. This aggregate value of the available bitrate Aᵢ(T), can be determined as follows:

$${A}_{i} ( T ) = \frac{{B}_{max}}{T} {\int }_{0}^{T} ( 1 - λ ( t ) ) ⅆ t \qquad ( 6 )$$

wherein λ(t) is a continuous function in time representing the fraction of the total capacity occupied by cross-traffic

It should be noted that network traffic is actually discrete, as packets do not fractionally occupy the network link at any given instant. The function λ(t) would be assigned a value of 0 when the path is void of competing cross-traffic at time t and a value of 1 when the path contains cross traffic. The continuous nature of λ(t) can be a good approximation when the coarse grained period T, is much greater than the time required for any packet to pass a given point along the network.

Assuming that a particular end-to-end path offers a one-way bitrate Bₘₐₓ to a target host from the source host, the derivation of Bₘₐₓ, the time between the trailing edge of the first marker packet M₀ and trailing edge of the last marker packet M₁ can be related to the maximum bitrate. If the available bitrate is assumed to be a simple fraction of the maximum bitrate, x*Bₘₐₓ, then the fraction x will determine the increase in total time required to pass the same amount of data from the source host to the target host and can be determined as follows:

$$\begin{matrix}Total bits sent = {B}_{max} * ( {t}_{1} - {t}_{0} ) \\ = {B}_{avail} * ( {t}_{2} - {t}_{0} ) \\ {B}_{avail} = {B}_{max} * x\end{matrix}$$

where the fraction x=(t₁−t₀)/(t₂−t₀) can be expressed in terms of the minimum TTT (α) and mean TTT (τ) and therefore x=α/τ

As an example, FIG. 12 illustrates a schematic representation of a comparison between the available bitrate and the maximum bitrate. Specifically, when cross traffic is not present in a portion of the network, the bitrate available will be the maximum bitrate, and the time between the trailing edge of the first marker packet and the trailing edge of the last marker packet is represented by t₁-t₀ as illustrated in FIG. 12(a). In the presence of cross traffic as illustrated in FIG. 12(b) the available bitrate is a fraction of the maximum bitrate and the time between the trailing edge of the first marker packet and the trailing edge of the last marker packet is represented by t₂-t₀. As can be noted, t₂ is greater than t₁, and as such the time for the passage of the same amount of information in the presence of cross traffic, will be increased.

The available bitrate Bₐᵥₐᵢₗ can be defined in terms of the first or last packet of the loads in an ordered group of packets, or in terms of the marker packets, depending on the assumptions that are taken and the network effects that are included. Since opposing traffic or other limiting effects are potentially sensitive to passage of the transmitted packets, the first packet of the loads may be most representative. Alternately, the presence of the load may be assumed to stabilize the variability of the opposing traffic and use of the last load packet may be appropriate. Use of the marker packets requires some assumptions about the limiting effects past the target host since the mean TTT of the markers, unlike the minimum RTT, may include any additional transient delays along the network path subsequent to load expiry. It should be noted that, use of the mean TTT implies assumptions about the nature of the return path relative to the outbound path that may be applicable in given circumstances.

Adaptive Sampling and Test Flow

As would be readily understood by a worker skilled in the art, the nature of packet-based network paths can be somewhat variable. Characterization of a path and its elements may be optimized with respect to the time taken for the characterisation process, the accuracy of results and the loads on the network path. According to one embodiment of the present invention, optimization of this sampling procedure can be achieved through the use of adaptive sampling and the application of related analyses. This adaptive sampling process commences with the evaluation of predetermined indicators which can result from a non-optimal sampling technique being used. Subsequently, one or more adaptation operations are performed in order to improve the sampling technique. Finally a process of convergence is used in order to determine if sufficient sampling has been performed in order to characterise the network path being evaluated to a desired level of accuracy.

In one embodiment, the adaptation process examines raw packet timings and loss values for patterns of sub-optimal sampling techniques, wherein these patterns are termed indicators. These indicators can enable the determination of alternate sampling techniques to which the network path under test should respond in an improved manner, from a sampling point of view. The adaptation process can iteratively make alterations or adaptations to the sampling technique until the most effective sampling technique for the network path under test can be determined. In addition the adaptation process may take place relative to one hop of network path under test in isolation of others, or optionally can be based on a complete or a sub-sequence of hops of the network path.

In one embodiment, the presence of indicators in sampling results can signify a sub-optimal sampling technique has been used. Alternately, zero indicators within a sampling results can signify that the sampling technique is effective for characterization of the network path under test. Within a particular sampling result there may be a plurality of indicators, which may signify multiple sub-optimal sampling technique parameters, or a plurality of indicator may signify a single, more specific, sub-optimal sampling technique parameter.

In one embodiment adaptation operations define alterations to a sampling technique and its parameters, wherein each operation can be designed to accommodate or compensate for a particular set of network conditions. A single operation or a plurality of operations may be applied to a sampling technique. Further, an operation may be applied repeatedly or alternately may be reversed, wherein the effect of the operation is negated to produce the opposite effect thereby providing a means to discover the desired effect from the network under test, for example.

In one embodiment, the set of one or more indicators present in a particular set of sampling results for a particular sampling technique can determine the operation applied to generate a more effective sampling technique. For example, one or a plurality of operations may be applied to the current sampling technique parameters, based on the indicators. The adaptation process can continue to monitor the sampling results for indicators of sub-optimal sampling techniques, and subsequently iteratively apply operations to the sampling technique until the most effective technique is discovered, for example. In one embodiment a sampling technique may be adapted only when sufficient evidence suggests the adaptation will produce more accurate results.

In one embodiment the process of convergence is performed wherein this procedure is a type of adaptive analysis that can examine the collected samples for the stability required for accurately determining network performance characteristics. The process of convergence can determine if the number of test samples already collected is sufficient to achieve stability and if this is not achieved, the process of convergence may indicate approximately how many more test samples are required for stability to be achieved.

In one embodiment of the present invention, during the adaptation process a history of past adaptations can be maintained, and during the adaptation process this history can be reviewed prior to making alterations to the sampling technique parameters. In some cases, an adaptation applied to parameters of a sampling technique that are designed to affect, may not produce the desired effect upon the subsequent sampling. When an indicator and subsequent one or more adaptation operations do not yield the desired effect, the adaptive process can limit the importance of the indicator for which the adaptation was performed. In this manner, the adaptive process can reduce the impact of selected indicators that have been ineffective in the past for the particular network path being evaluated.

Indicators

Indicators are undesirable characteristics or patterns in sampling result are representative of one or more sub-optimal sampling techniques. Zero indicators within a sampling result can signify that the sampling technique is effective for characterization the network path under test. Zero indicators within a sampling result, however, signify only that the sampling technique is effective, namely that is it free of undesirable characteristics, only for the set of characteristics represented by the defined indicators.

In one embodiment, several indicators of sub-optimal sampling technique parameters or of network stress, either intentional network safety mechanisms or unintended network defects, may be derived from raw packet timings and loss values. Theses indicators include, but not exclusive of: marker reordering, marker compression, load reordering, marker loss rate, load loss rate, reported network errors, slow end-host, and specific combinations of these conditions.

The following provides one way of determining these indicators from the collected data during the sampling procedure, however it would be readily understood that an alternate definition of each of the indicators can be derived.

Marker reordering occurs when the trailing marker passes the leading marker during network transmission. Therefore, by comparing the receive times of the leading and trailing marker packets can provide the marker reordering indicator, where a smaller trailing marker receive time indicates the markers changed positions during network transmission.

Marker compression is a milder form of marker reordering, wherein the marker packets are compressed, namely brought closer together, but do not change receive order. Comparing the difference in transmit times of the leading and trailing markers with the difference in receive times between those same packets can provide the marker compression indicator. A smaller receive time delta, within a predetermined threshold can indicate that the leading marker was delayed disproportionably during its network transmission when compared to the trailing marker.

Load reordering occurs when load packets change order during network transmission. The load reordering indicator can be considered as synonymous with the marker reordering indicator but being based on the load packets timings.

The marker packet loss indicator can be the observation of loss in one or more marker packets and the load loss indicator can be the observation of loss amongst one or more of the load packets.

Furthermore, reported network conditions can be explicit indications from network devices or layer 3 devices about network errors or network stress. These reported network condition indicators commonly take the form of, but not limited to, ICMP messages within the packet-based networks.

The slow end-host indicator can be defined as the ratio of the difference of the trailing and leading marker packet's TTT and the difference of the least most and the first most load packet's TTT, wherein a ratio sufficiently greater than 1 can indicate a slow end-host.

In one embodiment, for indicators that are based on packet loss, a packet can be considered as lost when a reasonable amount of time has elapsed since the initial sending of the packet, without the receipt of an acknowledgement reply packet. The definition of a reasonable amount of time before classifying a packet as lost can be dependent on the network path under test and can vary greatly within common packet-based network scenarios. It would be readily understood by a worker skilled in the art that there are several well known mechanisms for determining expected packet traversal times, which may be used to define a reasonable amount of time. In an alternate embodiment, negative acknowledgements can be used to identify packet loss.

Adaptation Operations

In one embodiment the adaptation operations are used in order to optimize the active sampling technique and the adaptation operations can be adjustments including changing load count, changing load size, changing marker size, ramping marker sizes, ramping load sizes, changing load packet parameters, changing marker packet parameters, and changing the number of iterations, for example.

In one embodiment of the present invention, the adaptation operations are defined as: 1) Changing the load count, by either increasing of decreasing the load count within bounds, can alter the demand on the network path under test. An increase in load count can put more demands on the network and target hosts, while decreasing the load count has the opposite effect. 2) Changing the load size, either increasing of decreasing the load size within bounds, can avoid some types of packet filtering and network defect conditions which can hinder the sampling process. 3) Changing the marker size, either increasing or decreasing the marker size within bounds, alters the demand on the network path and the destination host under test. For example, an increase in marker size puts more demands on the end-host and the network connecting the end-host to the rest of the network path. 4) ramping marker packet sizes can require altering the leading and trailing marker size independently to induce a forward slope, wherein the leading marker is smaller than the training marker or backwards slope wherein the leading marker is larger than the trailing marker. Changing marker packet sizes in this manner may alter the survivability and timing characteristics of each marker packet independently. 5) Ramping load packet sizes in order to induce a forward or backward slope to all packets within the load grouping. Changing load packet sizes in this manner can alter the survivability and timing characteristics of the load group as a whole. 6) Changing load packet parameters can explore network characteristics when handling a variety of probe packet configurations. Load packet parameters that can be altered include network protocol and network type of service among others for example. Load packets with different packet parameters may use different network paths to the same host, may have different response timing and loss characteristics, and may have different network policies applied. 7) Changing marker packet parameters can explore network characteristics coupled with end-host response when handling a variety of probe packet configurations. Marker parameters that can be adjusted include network protocol, time to live, and protocol specific parameters such as port number for example. Marker packets with different packet parameters may use different network paths to the target host, may have different target host response timing and loss characteristics, and may have different network policies applied. 8) Changing the number of iterations and/or number of samples that are performed to calculate high-level network measurements, for example available bandwidth, one-way bitrate and one-way propagation delay. This adaptation operation may be required as it can be equally undesirable to over sample the network as it is to under sample the network. For example, too many samples may incorporate long-range effects into the performance measurements as well as unnecessary test time and network traffic. Alternately, too few a number of samples may not capture the true nature of the network resulting in low accuracy of network performance evaluations.

The following table describes indicators, required pre-conditions and responses of the adaptive process according to one embodiment of the present invention. In one embodiment of the present invention, there may be a defined response for a particular indicator that is present in the sampling results, with the required pre-condition not being met. In this scenario, the history of the adaptation process can be used to determine the most effective sub-optimal testing technique, for example that can be used for the characterisation of the network being evaluated.

TABLE 2

| Indicator | Pre-condition | Response |
|---|---|---|
| Marker | greater Marker | Increase marker forward slope |
| reordering | forward | |
| | slope possible | |
| Marker | NOT greater | Change the marker technique such |
| reordering | Marker forward | that the marker packets expire at |
| | slope possible | the furthest reliable host from the |
| | | testing source, which must also be |
| | | further from the source than the |
| | | load target. |
| Marker loss | large Marker size | Decrease marker size unless |
| | | history advises otherwise |
| Marker loss | small Marker size | Change protocol unless history |
| | | advises otherwise |
| Load loss | large Load size | In combination reduce load size |
| | AND/OR large | and load count unless history |
| | Load count | advises otherwise |
| Marker | greater Marker | Increase marker forward slope |
| compression | forward slope | |
| | possible | |
| Marker | NOT greater | Change the marker technique such |
| compression | Marker forward | that the marker packets expire at |
| | slope possible | the furthest reliable host from the |
| | | testing source, which must also be |
| | | further from the source than the |
| | | load target. |
| Slow end- | large Load | In combination reduce marker |
| host AND | size AND/OR | |
| NOT | small Load | size, maintaining existing marker |
| Marker loss | count | slope, and increase load count |
| | | unless history advises otherwise |
| Marker | | Change protocol unless history |
| loss AND | | advises otherwise. |
| Load loss | | |
| Maker | | Change the marker technique such |
| loss AND | | that the marker packets expire at |
| NOT Load | | the furthest reliable host from the |
| loss AND | | testing source, which must also be |
| NOT End | | further from the source than the |
| host | | load target. |

Convergence

In one embodiment, the process of convergence associated with the adaptation process can provide one or more estimates relating to the amount of sampling required for accurate network performance characterization and can additionally determine if sufficient sampling has occurred. For example, it can be equally undesirable to either over sample the network or under sample the network. For example, if too many samples are taken, the sampling process can inadvertently capture long-range effects that may effect the network performance measurements as well as unnecessarily increase test time and network load. Alternately, if too few samples are taken, the network performance characterizations derived from those samples can have a large confidence interval, reducing the effectiveness of the resulting calculations, namely the accuracy thereof.

In one embodiment, the convergence process can evaluate a convergence indicator in relation to itself over the sampling period. In one embodiment, there are three convergence indicators that can be associated with network performance characterization, each of which can capture the stability of one of intransient, transient or diagnostic characteristics, wherein intransient characteristics or measures are fixed in time, transient characteristics or measures vary in time and diagnostic characteristics can form the basis of inferences regarding network dysfunction.

In one embodiment of the present invention, the rate at which a convergence indicator approaches its equilibrium value can be monitored until some reasonable asymptotic value can be assumed. The implementation of this aspect of the present invention can be based on a comparison of the current statistical value of the convergence indicator against previous values in order to determine selected convergence indicator's rate of change relative to the rate of sampling. For example, if the minimum time travel for a specific packet in the series has not changed for the last x samplings, any measure depending on those minimum values can be considered stable relative to any anticipated value.

In one embodiment, the three convergence indicators are based solely on packet timings and loss distributions and do not require higher level information or access to large amounts of historical information. The transient network characteristic indicator is the mean value of the RTT or TTT for selected packets, typically the last load packet or trailing marker packet. The intransient network characteristics indicator is the smallest packet delta TTT of one of the packets or combination of packets, typically the marker packets. The diagnostics network characteristic indicator is the packet loss distribution for each of the load and marker packets in the series of packets in a particular sample.

In one embodiment, the convergence process comprises five stages, where the first three stages are invoked with each new sample, and the remaining two stages are invoked periodically or on demand. Separating the stages in this manner can permit functions with higher computational requirements to be scheduled less frequently, thereby reducing the overall computational requirement for the convergence analysis. In particular the convergence process examines a convergence indicator over the sampling period for stability relative to accumulated samples. When the accumulated sample distribution accurately estimates the population distribution, the sample distribution is considered to have converged. As such, when a sample distribution has converged, adding new samples to the distribution will not significantly alter the distribution.

In one embodiment of the present invention, the five stages of convergence are 1) Percent change function; 2) Binary string encoder; 3) Entropy encoder; 4) Entropy analysis function; and 5) Convergence indicator stability function.

The first stage of convergence is provided by a percent change function which compares a convergence indicator before and after a sample is combined with the existing collection of samples. Furthermore, one or more percent change functions may be combined to form a more comprehensive percent change function for this stage of convergence. For example, a sample percent change implementation for intransient network characteristics may comprise calculating the percent change between the fastest TTT time for the leading and the trailing markers and the greatest percentage change between these two convergence indicators can be taken as the overall percent change function.

The second stage of convergence is provided by a binary string function which encodes a string of ones and zeros, appending a single digit to the string for each sample collected. The function appends a one when the percent change function result for a particular sample is larger than a predetermined threshold, otherwise it appends a zero.

The third stage of convergence is provided by an entropy encoder which removes redundant information from the binary string to produce an entropy string. As a sample implementation, the binary string is entropy encoded using a form of a run-length encoding method. Alternately, any entropy encoder may be used in place of the run length encoder. In another embodiment, the sample implementation entropy encoder may not require a reverse transformation, thereby allowing improvements to time and space requirements during the performance of the convergence process.

The fourth stage of convergence is provided by an entropy analysis function which determines the amount of entropy contained in later portions of the entropy string compared to the amount of entropy in earlier portions of the entropy string. Determining the amount of entropy in different portions of the string can be estimated by examining the length of those portions in the entropy encoded string. A longer entropy string relative to the input string length indicates more entropy, while a shorter string indicates less entropy. For example, as the overall sample stabilizes, the end of the string contains less entropy.

The final stage of convergence is provided by the evaluation convergence indicator stability which examines the entropy at the end of the binary string against the remainder of the string.

In one embodiment a sample implementation of the convergence indicator stability evaluation splits the string into a minimal entropy string and a remainder string. The minimal entropy string is found by searching through the entropy string for the sub-string containing the last binary digit and containing the least amount of entropy. The ratio between the entropy values of the remainder string and the minimal entropy string form the entropy ratio. The entropy ratio may optionally be mapped onto a function that translates the entropy ratio into an appropriately scaled percent converged value. In this implementation, the ratio can be mapped onto a quadratic of the form as follows:

$$\frac{{ratio}^{2}}{4} = converged \% \qquad ( 8 )$$

In an alternate embodiment, a sample implementation of the convergence indicator stability calculates the first and second statistical moments of the run-length encoded string's numeric values namely the run-length moments. The ratio of last run-length value and the positive three-sigma value of the run-length moments form the entropy ratio. The entropy ratio is then mapped onto the function of the form as follows:
ratio=converged % (9)
Test Flow Logic

In one embodiment of the present invention, test flow can be modified as part of a feedback process for the adaptive sampling procedure, wherein the outcomes of the sampling stage may modify the subsequently selected sampling parameters and the subsequent selection of sampling objectives.

The test flow logic can control the mechanisms described for adaptation operations, and convergence. This logic can also identify and eliminate aspects of the measurement process that are redundant, conditional, optional or otherwise inappropriate to achieve test objectives.

In one embodiment, test flow logic can require connectivity between the source and destination hosts be assessed prior to the execution of the balance of the test. With regard to parameterization, the measurement of the path MTU from the source host to the destination host establishes the maximum packet size that can be effectively used, since packets exceeding the path MTV are typically lost. For example, in a sophisticated implementation, rate-limiting within the network path may be detected and identified with respect to the packet loss pattern resulting in the adaptation of the sampling stage to either avoid or account for the influence of the detected rate-limiting. In addition, slow convergence or lack of convergence of one or more indicators during the sampling stage may result in an adaptation cycle that selects an optimal sampling mode, for example.

Variations

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as a personal computer, server or the like and pursuant to one or more, or a part of one or more, program elements, modules or objects generated from any programming language, such as C++, Java, P1/1, or the like. In addition, each step, or a file or object or the like implementing each said step, may be executed by special purpose hardware or a circuit module designed for that purpose.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for characterizing an end-to-end path of a packet-based network, said end-to-end path including two or more nodes, said method comprising the steps of:
a) generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path;
b) transmitting said one or more ordered groups of packets from said source host along said common end-to-end path;
c) collecting data relating to the transmission of said one or more ordered groups of packets; and
d) analysing said data thereby developing characteristics of the end-to-end path.

2. The method according to claim 1, wherein said step of collecting data is performed at a sink host.

3. The method according to claim 2, wherein said sink host is the source host.

4. The method according to claim 2, wherein said sink host is a node outside of the end-to-end path.

5. The method according to claim 1, wherein the step of generating the one or more ordered groups of packets comprises configuring said one or more load packets with a time-to-live value.

6. The method according to claim 1, wherein the step of generating the one or more ordered groups of packets comprises configuring said one or more load packets to cause a Port Unreachable response from the predetermined node.

7. The method according to claim 5, wherein said end-to-end path comprises one or more target hosts located between the source host and the destination host, and said time-to-live value is set for the one or more loads to expire at one of the one or more target hosts.

8. The method according to claim 1, wherein said step of generating the one or more ordered groups of packets comprises configuring said one or more load packets and said two or more marker packets using a protocol selected from the group comprising ICMP, UDP and TCP.

9. The method according to claim 1, wherein the step of generating the one or more ordered groups of packets comprises configuring said two or more marker packets with a time-to-live value in order that said two or more marker packets expire prior to reaching said destination host, wherein expiry of said two or more marker packets occurs subsequent to said marker packets traversing the predetermined node.

10. The method according to claim 1, wherein the step of collecting data comprises collection of time data relating to transmission of the one or more ordered groups of packets from the source host and reception of replies to the ordered group of packets at a sink host.

11. The method according to claim 10, wherein the step of collecting data is performed until a statistical significant amount of time data has been collected.

12. The method according to claim 10, wherein the step of analysing said data comprises evaluating one or more of total trip time, minimum total trip time, maximum total trip time, mean total trip time, standard deviation of total trip time and loss rate for one or more of the two or more marker packets and the one or more load packets.

13. The method according to claim 1, wherein said one or more ordered groups of packets comprise a first marker packet followed by one or more load packets followed by a second marker packet.

14. The method according to claim 13, wherein the step of analysing said data comprises determining a one-way bitrate.

15. The method according to claim 13, wherein the step of analysing said data comprises determining a one-way propagation delay.

16. The method according to claim 13, wherein the step of analysing said data comprises determining a one-way delay variation.

17. The method according to claim 13, wherein the step of analysing said data comprises determining a one-way available bitrate.

18. The method according to claim 14, wherein the one-way bitrate, Bₘₐₓ is determined substantially as follows:
Bₘₐₓ=(n*S_{L}+S_{M})/(Λ₁−Λ₀)
where n is a number of load packets, S_{L} is a size of one load packet, S_{M} is a size of one marker packets, Λ₁ is a minimum total-trip-time for the second marker packet and Λ₀ is a minimum total-trip-time for the first marker packet.

19. The method according to claim 16, wherein the one-way delay variation is determined substantially by evaluating a coefficient of variation of a standard deviation and a mean of a total-trip-time for either a first load packet or a last load packet.

20. The method according to claim 18, wherein the one-way available bitrate, Bₐᵥₐᵢₗ is determined substantially as follows:
Bₐᵥₐᵢₗ=Bₘₐₓ*[(t₁−t₀)/(t₂−t₀)]
where (t₁-t₀) is time between a trailing edge of the first marker packet and a trailing edge of a last marker packet at the maximum bitrate and (t₂-t₀) is time between a trailing edge of the first marker packet and a last marker packet at the available bitrate.

21. The method according to claim 1, wherein the step of modifying includes determining one or more indicators, and modifying one or more parameters of said one or more ordered groups of packets based on said one or more indicators.

22. The method according to claim 21, wherein step of modifying said parameters is selected from the group comprising changing number of load packets, changing load packet size, changing marker packet size, ramping marker packet sizes, ramping load packet sizes, changing load packet protocol, changing marker packet protocol and changing the destination host.

23. The method according to claim 21, wherein the step of modifying parameters is performed in an iterative manner in order to obtain an optimised sampling procedure.

24. The method according to claim 1, further comprising the step of evaluating convergence of data collected.

25. The method according to claim 24, wherein the step of evaluating convergence comprises the steps of percent change function evaluation, binary string function evaluation, entropy encoding, entropy analysis function evaluation and evaluation of stability of a convergence indicator.

26. An apparatus for characterizing an end-to-end path of a packet-based network, said apparatus comprising:
a) means for generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path;
b) means for transmitting said one or more ordered groups of packets from said source host along said common end-to-end path;
c) means for collecting data relating to the transmission of said one or more ordered groups of packets; and
d) means for analysing said data thereby developing characteristics of the end-to-end path.

27. The apparatus according to claim 26 further comprising a means for adaptively modifying generation of the one or more ordered groups of packets based on collected data, said means for adaptively modifying for optimizing characterization of the end-to-end path.

28. The apparatus according to claim 26 further comprising a means for evaluating convergence of data collected.

29. A computer program product comprising a computer readable medium having a computer program recorded thereon for performing a method for characterizing an end-to-end path of a packet-based network comprising the steps of:
a) generating one or more ordered groups of packets each including two or more marker packets and one or more load packets, all of said packets being configured to travel along a common end-to-end path defined by a source host and a destination host, wherein said one or more load packets are configured to traverse the end-to-end path to a predetermined node, said predetermined node being any node along the end-to-end path;
b) transmitting said one or more ordered groups of packets from said source host along said common end-to-end path;
c) collecting data relating to the transmission of said one or more ordered groups of packets; and
d) analysing said data thereby developing characteristics of the end-to-end path.
